(19) United States
(12) Patent Application Publication
(10) Pub. No.: US 2024/0288827 A1
(43) Pub. Date: Aug. 29, 2024

(54) BALANCE WHEEL FOR A CLOCKWORK RESONATOR MECHANISM FITTED WITH LATERAL INERTIA ADJUSTING WEIGHTS

(71) Applicant: The Swatch Group Reseach and Development Ltd, Marin (CH)

(72) Inventors: Gianni DI DOMENICO, Neuchãtel (CH); Mohammad Hussein Kahrobaiyan, Boudevilliers (CH); Dominique Lechot, Les Reussilles (CH)

(73) Assignee: The Swatch Group Reseach and Development Ltd, Marin (CH)

(21) Appl. No.: 18/432,415

(22) Filed: Feb. 5, 2024

(30) Foreign Application Priority Data
Feb. 28, 2023 (EP) 23159143.9

(51) Int. Cl. G04B 18/04; G04D 7/12

(52) U.S. Cl. CPC G04B 18/04; G04D 7/1257

(57) ABSTRACT

A balance wheel (15) for a clockwork resonator mechanism (1), including a main arm (6) arranged along a longitudinal axis, the balance wheel (15) including at least a first lateral weight (11) for adjusting the inertia of the balance wheel, the first lateral weight (11) being mounted so as to be able to move on the main arm (6) of the balance wheel (15) so as to be able to adopt a plurality of positions more or less close to the main arm (6) in order to adjust the inertia of the balance wheel (15). Also, a method for developing the resonator mechanism.

### CROSS REFERENCE TO RELATED APPLICATIONS

This application claims priority to European Patent Application No. 23159143.9, filed on Feb. 28, 2023, the disclosure of which is incorporated by reference herein their entireties

### FIELD OF THE INVENTION

The invention concerns an adjustable inertia balance for a clockwork resonator mechanism.

The invention also relates to a resonator mechanism for a watch movement including at least one such balance wheel.

The invention also concerns a method for setting up the resonator mechanism.

### BACKGROUND TO THE INVENTION

New mechanism architectures make it possible to maximise the quality factor of a resonator, by using a flexible guide with the use of a lever escapement with a very small angle of lift, according to application CH15442016 in the name of ETA Manufacture Horlogere Suisse and its derivatives, the teachings of which are directly usable in the present invention.

Application CH5182018 or application EP18168765 in the name of ETA Manufacture Horlogère Suisse describes a watch resonator mechanism, including a structure carrying, by means of a flexible suspension, an anchoring block from which is suspended an inertial element oscillating according to a first rotational degree of freedom RZ, under the action of return forces exerted by a virtual pivot including first elastic blades each fixed to said inertial element and to said anchoring block, the flexible suspension being arranged to allow a certain mobility of the anchoring block in all the degrees of freedom other than the first rotational degree of freedom RZ in which only the inertial element is mobile to avoid any disturbance of its oscillation, and the stiffness of the degrees of freedom of the balance other than the first rotational degree of freedom RZ is very much greater than the stiffness of the virtual pivot in this same first rotational degree of freedom RZ.

Application CH715526 or application EP3561607 in the name of ETA Manufacture Horlogere Suisse describes a clock resonator mechanism, including a structure and an anchoring block from which is suspended at least one inertial element arranged to oscillate with a first degree of freedom in rotation RZ about a pivot axis extending in a first direction Z, said inertial element being subjected to return forces exerted by a virtual pivot including a plurality of substantially longitudinal resilient blades, each fixed at a first end to said anchoring block and at a second end to said inertial element, each said resilient blade being deformable essentially in a plane XY perpendicular to said first direction Z.

When the resonator mechanism is in operation, the inertial element performs an oscillatory movement about the Z direction in the XY plane with a reference oscillation frequency. In addition, the inertial element can also perform rotary secondary oscillations about the X direction on the one hand, and about the Y direction on the other. These secondary oscillations are oscillatory modes known as “out-of-plane”, i.e. outside the main XY plane of oscillation of the inertial element.

These “out-of-plane” secondary oscillations have a more or less limited effect on the movement of the regulating organ.

However, if the frequency of these secondary oscillations is a multiple of the reference frequency of the inertial element in the XY plane, the secondary oscillations are larger and disturb the operation of the oscillator. It is therefore important to ensure that the frequency of the secondary oscillations differs by a multiple of the reference frequency.

### SUMMARY OF THE INVENTION

The invention proposes to improve the resonator mechanism of the CH715526 application or the EP3561607 application in the name of ETA Manufacture Horlogere Suisse in order to avoid the disadvantages mentioned above.

To this end, the invention relates to a balance for a clockwork resonator mechanism, including a main arm arranged along a longitudinal axis.

The balance wheel is remarkable in that it comprises at least a first lateral weight for adjusting the inertia of the balance wheel, the first lateral weight being movably mounted on the main arm of the balance wheel so that it can adopt a plurality of positions more or less close to the main arm in order to adjust the inertia of the balance wheel.

Thanks to this invention, the balance wheel can be adjusted to control and avoid significant secondary oscillations about at least one axis, in particular in the X direction passing through the centre of mass of the balance wheel, the secondary oscillations occurring in the YZ plane perpendicular to the XY plane of oscillations.

This lateral adjustment weight or weights enable the secondary oscillation frequency to be modified and selected so as to avoid a multiple of the reference oscillation frequency of the balance in the XY plane. In this way, the resonator mechanism fitted with such a balance is more precise.

In addition, the lateral adjustment weights have no significant effect on the reference oscillations about the Z direction.

According to a particular embodiment of the invention, the first side feeder is arranged perpendicular to the longitudinal axis of the main arm so that the frequency of oscillation of the main arm about its longitudinal axis can be modified.

In a particular embodiment of the invention, the first lateral weight is movable in the main plane of the balance wheel.

According to a particular embodiment of the invention, comprises a second lateral inertia adjustment weight arranged on the main arm symmetrically to the first lateral weight with respect to the longitudinal axis of the main arm.

According to a particular embodiment of the invention, the lateral feeder(s) are screws.

In a particular embodiment of the invention, the lateral weight or weights are off-centre on the arm of the balance wheel.

According to a particular embodiment of the invention, the balance wheel also comprises at least one peripheral inertia adjustment weight, mounted on two ends of the main arm.

In a particular embodiment of the invention, the balance wheel comprises a hub.

In a particular embodiment of the invention, the main arm includes an enlarged part where the lateral adjustment weight or weights are arranged.

The invention further relates to a resonator mechanism comprising a structure and an anchor block from which is suspended at least one inertial element arranged to oscillate with a first rotational degree of freedom RZ about a pivot axis extending in a first direction Z, said inertial element being configured to be subjected to restoring forces exerted by restoring means configured to cause the inertial element to oscillate, the inertial element comprising such a pendulum.

In a particular embodiment of the invention, the balance wheel is mounted so that the longitudinal axis is substantially perpendicular to the first Z direction.

In a particular embodiment of the invention, the balance wheel is mounted so that the main plane of the balance wheel is substantially perpendicular to the first Z direction.

The invention also relates to a method of developing such a clock resonator mechanism, the method comprising:
a first step of measuring a reference oscillation frequency of the inertial element about the Z direction in the XY plane,
a second step for measuring at least one secondary oscillation frequency of the inertial element in the YZ plane about the X direction,
a third step of comparing the secondary oscillation frequency with the reference oscillation frequency, to verify that the secondary oscillation frequency has a value substantially different from a multiple of the reference oscillation frequency, and
in the event that the secondary oscillation frequency has a value close to or substantially equal to a multiple of the reference oscillation frequency, a fourth step of modifying the position of the control weight(s) relative to the main arm so that the secondary oscillation frequency is substantially different from a multiple of the reference oscillation frequency.

According to a particular embodiment of the invention, the method comprises a fifth verification step, in which the secondary oscillation frequency is measured to verify that the new position of the lateral adjustment weights makes it possible to obtain a value other than a multiple of the reference oscillation frequency.

### BRIEF DESCRIPTION OF THE DRAWINGS

Further features and advantages of the invention will become apparent from the following detailed description, with reference to the attached drawings, where:

FIG. 1 shows a schematic perspective view of a flexible reed resonator mechanism including a balance wheel in accordance with the invention,

FIG. 2 shows a schematic side view of the flexible reed resonator mechanism shown in FIG. 1,

FIG. 3 shows a schematic view of the balance wheel as seen from below, and

FIG. 4 shows a schematic diagram of the process for developing the resonator mechanism according to the invention.

### DETAILED DESCRIPTION OF PREFERRED EMBODIMENTS

The invention primarily concerns a balance wheel and a resonator mechanism for clocks including such a balance wheel.

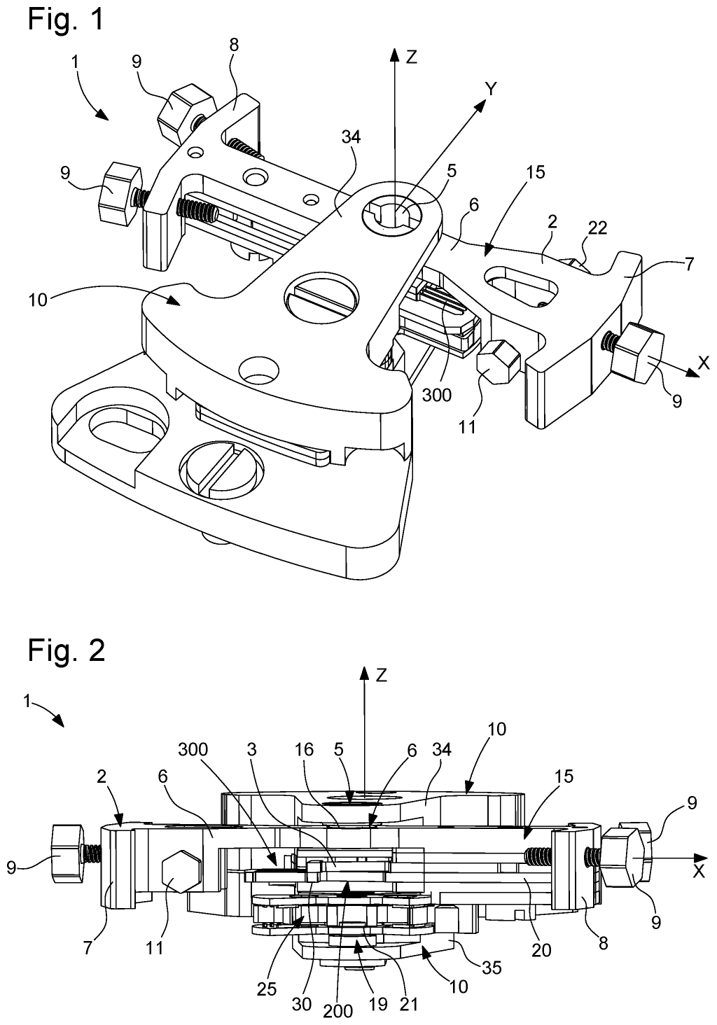

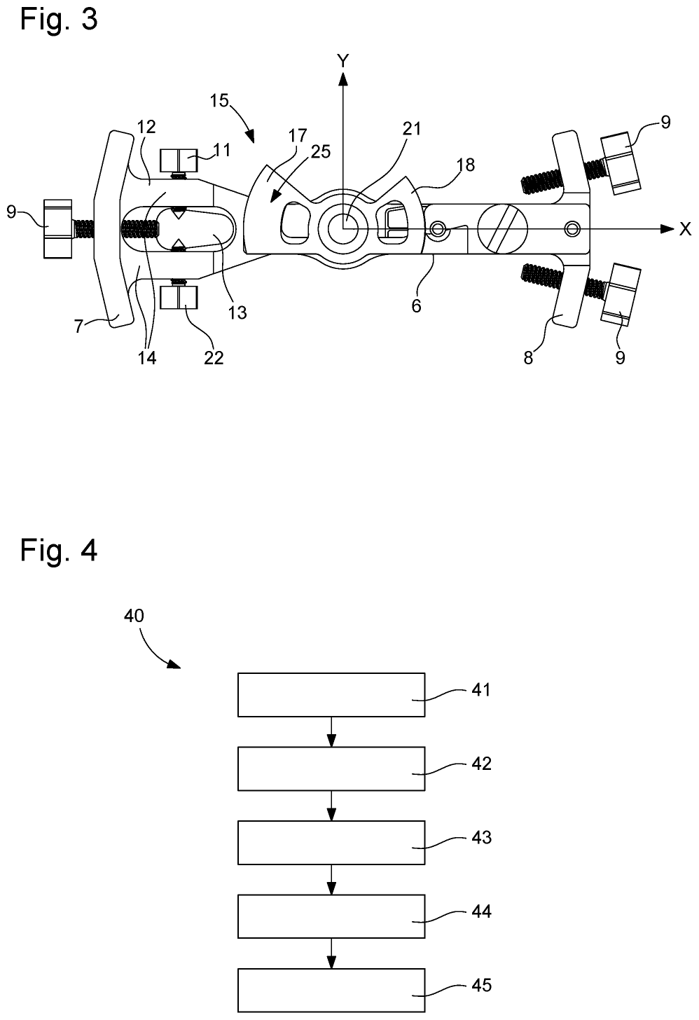

In FIGS. 1 and 2, this clockwork resonator mechanism 1 includes a structure 10 and an anchoring block 30, from which is suspended at least one inertial element 2 arranged to oscillate in a first rotational degree of freedom RZ about a pivot axis extending in a first direction Z. The anchoring block 30 is suspended from the structure 10 by a flexible suspension 300 equipped with flexible blades, which is arranged to allow the anchoring block 30 to move in five flexible degrees of freedom of the suspension, which are:
a first degree of translational freedom in the first direction Z,
a second degree of freedom in translation along a second direction X orthogonal to the first direction Z,
a third degree of freedom in translation along a third direction Y orthogonal to the second direction X and the first direction Z,
a second rotational degree of freedom RX about an axis extending in the second direction X, and
a third degree of freedom in rotation RY about an axis extending in the third direction Y.

The structure 10 includes an upper platform 34 and a lower platform 35, between which the inertial element 2 is suspended.

This inertial element 2 is subjected to return forces exerted by return means. In the embodiment, the return means are a flexible pivot 200 including a plurality of substantially longitudinal elastic blades 3, each fixed at a first end to the anchoring block 30, and at a second end to the inertial element 2. In the figures, the resonator mechanism 1 includes two crossed elastic blades 3. One resilient strip 3 is deformable essentially in a plane XY perpendicular to the first direction Z.

Thanks to the return means, the inertial element 2 can oscillate in the XY plane, with the first Z direction perpendicular to the XY plane.

The inertial element 2 comprises a clamp 20 to which the elastic blades 3 are attached.

The inertial element 2 also comprises a balance 15 connected to the attachment 20. The balance 15 is elongated in the shape of a substantially symmetrical bone. Rocker arm 15 comprises a main arm 6 arranged along a longitudinal axis of rocker arm 15 corresponding to direction X when mechanism 1 is at rest and the rocker arm is not oscillating.

The balance 15 also comprises two ends 7, 8 of the main arm 6, which are wider than the main arm 6. For example, the ends 7, 8 and the main arm 6 are made of the same material. Alternatively, the ends 7, 8 are mounted on the main arm 6.

Peripheral inertia weights 9 are mounted on each end 7, 8. The first end 7 comprises one peripheral inertia weight 9 and the second end 8 comprises two axial inertia weights 9. These peripheral adjusting weights 9 enable the rate of the resonator mechanism to be adjusted by modifying the inertia of the balance wheel 15, in particular with respect to the Z direction.

These peripheral weights 9 also enable the position of the centre of mass of the inertial element 2 to be adjusted in the X and Y directions. The peripheral weights 9 are adjusted using a procedure that is well known to those skilled in the art. Simply by measuring the travel in the four vertical positions, it is possible to deduce the displacements required for each of the three peripheral weights 9, using equations known to those skilled in the art.

Preferably, these peripheral weights 9 are screws whose position can be modified in relation to the ends 7, 8.

The inertial element 2 is configured to oscillate at least in part about a first pivot stud 5 extending from the upper platform 34 of the structure 10, the pivot stud 5 being configured to allow the inertial element 2 to pivot about it.

To this end, the main arm comprises a hub 16 for inserting the first pivot stud 5. The hub 16 has a larger diameter than the first stud 5 to allow the pendulum 15 to rotate around it. Hub 16 is preferably arranged in the middle of the arm.

According to the invention, the balance wheel 15 comprises at least one lateral weight 11 for adjusting the inertia of the balance wheel 15, the weight 11 being mounted on the main arm 6. In this embodiment, the balance wheel 15 comprises two lateral weights 11 mounted on the main arm 6. The two lateral weights 11 are mounted symmetrically on the main arm 6 with respect to the longitudinal axis of the balance 15.

These lateral weights 11 are arranged perpendicular to the longitudinal axis of the main arm 6 so that the oscillation frequency of the main arm 6 about its longitudinal axis can be modified. The lateral weights 11 can also be moved in the main plane XY of the balance wheel 16.

Each side weight 11 is mobile so that it can take up a plurality of positions more or less close to the main arm 6. In this way, the inertia of the balance can be adjusted about direction X. When the weights are moved away from the main arm, the inertia of the balance wheel about the X direction is increased, whereas when the weights are moved closer to the main arm, the inertia of the balance wheel 15 about the X direction is reduced.

The side weights 11 are screws with a polygonal head and a threaded shank extending from the polygonal head. In order to increase the range of adjustment of the inertia about the X direction, it is possible to manufacture several variants of the lateral weights 11 with heads of different sizes.

The lateral weights 11 are also off-centre on the main arm 6 towards the first end 7. The main arm 6 has an enlarged section 12 in which the lateral adjustment weights 11 are arranged. The widened section 12 extends from the first end 7, and comprises a central cavity 13 bordered by two side walls 14, into which the screws are screwed.

Thanks to these lateral weights 11, it is possible to modify the secondary oscillation frequency of the balance wheel 15 about the X direction, in particular to avoid a multiple value of the reference oscillation frequency of the balance wheel 15 about the Z direction in the XY plane.

The inertial element 2 also comprises an anchor 25 assembled under the attachment 20, the anchor 25 being centred on the balance wheel 15 and the hub 16. The anchor 25 comprises two main arms 17, 18 in the form of arcs of a circle, the ends of which are configured to cooperate with an escapement wheel, not shown in the figures. The escapement may be of the mechanical or magnetic type, or a combination of the two of the magneto-mechanical type.

A second pivot stud 19 extending from the lower platform 35 of the structure 10 is inserted into the anchor 25 along the axis of rotation of the inertial element 2. The anchor 25 comprises a second hole 21 into which the second stud 19 is inserted, the second hole 21 being wider than the second stud 19 to avoid contact between the anchor 25 and the second hole 21. The second stud 19 is arranged in line with the first stud 5. In this way, the inertial element 2 surrounds the first stud 5 and the second stud 19, which are inserted, one in the balance wheel 15 and the other in the anchor 25, so as to allow the inertial element 2 to oscillate along an axis of rotation passing through the two studs 5, 19. The amplitude of oscillation of the inertial element 2 in the plane of oscillation is, for example, in the range 20 to 40°. The frequency of oscillation is, for example, greater than ten Hertz.

The invention also relates to a method of tuning 40 a clock resonator mechanism such as that presented above, in order to avoid significant secondary oscillations in planes perpendicular to the XY plane, in particular secondary rotary oscillations about the X direction.

Shown in FIG. 4, the method 40 comprises a first step 41 of measuring a reference oscillation frequency of the inertial element 2 about the Z direction in the XY plane. To this end, the number of oscillations of the inertial element 2 per second is measured. For example, a measurement method using a laser measurement system is used, which is well known to those skilled in the art.

In a second step 42, a secondary oscillation frequency of the inertial element 2 in the YZ plane about the X direction is measured.

A third step 43 consists of comparing the secondary oscillation frequency with the reference oscillation frequency. More specifically, it is checked whether the secondary oscillation frequency has a value substantially different from a multiple of the reference oscillation frequency.

If the secondary oscillation frequency has a value that is substantially different from a multiple of the reference oscillation frequency, the position of the lateral adjustment weights 11 relative to the main arm 6 is not changed.

If the secondary oscillation frequency has a value close to or substantially equal to a multiple of the reference oscillation frequency, the method comprises a fourth step 44. The fourth step 44 consists of modifying the position of the lateral adjustment weights 11 relative to the main arm 6 so that the secondary oscillation frequency is substantially different from a multiple of the reference oscillation frequency.

The method may include a fifth verification step 45, in which the secondary oscillation frequency is measured to verify that the new position of the lateral adjusting weights 11 makes it possible to obtain a value other than a multiple of the reference oscillation frequency. Thus, if necessary, the position of the lateral weights 11 can be changed again if the measured secondary oscillation frequency is not satisfactory.

Of course, the present invention is not limited to the example illustrated, but is susceptible to various variants and modifications which will become apparent to those skilled in the art.

1. A pendulum (15) for a clockwork resonator mechanism (1), including a main arm (6) arranged along a longitudinal axis, comprising at least a first lateral weight (11) for adjusting the inertia of the pendulum, the first lateral weight (11) being mounted so as to be able to move on the main arm (6) of the pendulum (15) so as to be able to adopt a plurality of positions more or less close to the main arm (6) in order to adjust the inertia of the pendulum (15).

2. The pendulum as claimed in claim 1, wherein the lateral flyweight (11) is arranged perpendicular to the longitudinal axis of the main arm (6) in order to be able to modify the frequency of oscillation of the main arm (6) about its longitudinal axis.

3. The pendulum as claimed in claim 1, wherein the lateral weight (11) is movable in the main plane of the pendulum (15).

4. The pendulum according to claim 1, further comprising a second lateral inertia adjuster (22) arranged on the main arm (6) symmetrically to the first lateral inertia adjuster (11) with respect to the longitudinal axis of the main arm (6).

5. The pendulum according to claim 1, wherein the lateral weight or weights (11, 22) are screws.

6. The pendulum according to claim 1, wherein the lateral weight or weights (11, 22) are off-centre on the main arm (6) of the pendulum (15).

7. The pendulum according to claim 1, further comprising at least one axial peripheral weight (9) for adjusting the inertia, mounted on two ends (7, 8) of the main arm (6).

8. The pendulum according to claim 1, further comprising a hub (16).

9. The pendulum according to claim 1, wherein the main arm (6) includes an enlarged part (12) where the lateral adjustment weight or weights (11, 22) are disposed.

10. A resonator mechanism (1) comprising a structure (10) and an anchoring block (30) from which is suspended at least one inertial element (2) arranged to oscillate with a first rotational degree of freedom RZ about a pivot axis (D) extending in a first direction Z, said inertial element (2) being configured to be subjected to return forces exerted by return means configured to cause the inertial element (2) to oscillate, wherein the inertial element (2) comprises the balance (15) according to claim 1.

11. The resonator mechanism according to claim 10, wherein the balance (15) is mounted so that the longitudinal axis of the main arm (6) is substantially perpendicular to the first Z direction.

12. A resonator mechanism as claimed in claim 10, wherein the pendulum (15) is mounted so that the main plane of the pendulum (15) is substantially perpendicular to the first Z-direction.

13. A method (40) for developing a clockwork resonator mechanism (100) according to claim 10, comprising:
a first step (41) of measuring a reference oscillation frequency of the inertial element (2) about the Z direction in the XY plane,
a second step (42) of measuring at least one secondary oscillation frequency of the inertial element (2) in the YZ plane about the X direction,
a third step (43) of comparing the secondary oscillation frequency with the reference oscillation frequency, to check that the secondary oscillation frequency has a value substantially different from a multiple of the reference oscillation frequency, and in the event that the secondary oscillation frequency has a value close to or substantially equal to a multiple of the reference oscillation frequency, a fourth step (44) of modifying the position of the control weight or weights relative to the main arm so that the secondary oscillation frequency is substantially different from a multiple of the reference oscillation frequency.

14. The method according to claim 13, further comprising a fifth verification step (45), in which the secondary oscillation frequency is measured to verify that the new position of the lateral adjustment weights (11) makes it possible to obtain a value other than a multiple of the reference oscillation frequency.
